(19) United States
(12) Patent Application Publication
(10) Pub. No.: US 2006/0254832 A1
(43) Pub. Date: Nov. 16, 2006

(54) SUSPENSION SYSTEM FOR A TRACK CHASSIS

(76) Inventor: Russell W. Strong, Craftsbury Common, VT (US)

Correspondence Address: ARTZ & ARTZ, P.C., 28333 TELEGRAPH RD., SUITE 250, SOUTHFIELD, MI, 48034, US

(21) Appl. No.: 11/382,778

(22) Filed: May 11, 2006

Related U.S. Application Data
(60) Provisional application No. 60/680,593, filed on May 11, 2005.

(51) Int. Cl. B62D 55/00

(52) U.S. Cl. 180/9.5

(57) ABSTRACT

A suspension system for a track chassis on a vehicle with a rotatable drive axle is disclosed herein. The suspension system includes a track frame, a rotatable drive wheel, a plural number of support bars, a plural number of bogie wheels, and a closed-loop track. The track frame is mounted to the vehicle, and the drive wheel is in rotary communication with the drive axle of the vehicle. The support bars are pivotally attached in independent fashion to the frame, and multiple bogie wheels are rotatably mounted to each of the support bars. The track is looped about the drive wheel and the bogie wheels so as to engage the outer peripheries of the drive wheel and the bogie wheels.

### CROSS REFERENCE TO A RELATED APPLICATION

The present invention claims priority from U.S. Provisional Application Ser. No. 60/680,593 entitled “Suspension System for a Track Chassis,” which was filed on May 11, 2005.

### FIELD OF THE INVENTION

The present invention generally relates to an improved chassis suspension system for a vehicle. The present invention more particularly relates to a chassis suspension system for a track mechanism on a vehicle.

### BACKGROUND OF THE INVENTION

Tracks employed for ground movement in off-road vehicles such as bulldozers, tanks, snowmobiles, utility or construction vehicles, and the like are generally well known by persons who operate such vehicles and those skilled in the art. During operation of each such vehicle that employs tracks instead of conventional tires for ground movement, the vehicle's track support system or chassis must generally be rigid enough to support the weight of the vehicle on all points of contact between its tracks and any ground formation, structure, or object that the vehicle may have to drive over. The inclusion of an independent suspension for the vehicle's track bed support, which may include one or more bogie wheels or compound slide rails, can help soften the vehicle's ride over an object as its tracks move and progress over the object as the vehicle is driven. When driving such a vehicle over particularly large-sized objects in this manner, however, the overall tension in one or more of the vehicle's tracks is sometimes significantly affected, thereby either significantly increasing or decreasing the tension in the track(s) depending on the particular configuration of the vehicle's suspension.

Through experience, persons who operate such tracked vehicles have come to know that the characteristically rigid track chassis on such a vehicle, when the vehicle simply employs one track on each of its two sides without having any other balance-stabilizing device such as a ground-engaging tire or ski working in conjunction with the track(s), can sometimes give rise to a situation of “teetering” wherein the vehicle attempts to travel over a large object of significant height, even if the vehicle includes a dampened bogie wheel system. Such teetering is particularly apt to occur when the vehicle is driving, for example, out of a ditch, over a levee, over a sizable object such as 4″×4″, or when cresting a sharp hillock or ridge on a terrain. A conventional vehicle simply employing four tires and a tracked vehicle with four separate tracks are generally both not prone to such teetering because the front and rear tires or tracks of such vehicles are able to go over such raised terrain independently so that each such vehicle generally maintains three or more points of balanced contact with the ground at all times. In contrast, a tracked vehicle that simply employs two tracks, when cresting on an object, generally transitions from three or more points of contact, to two points of contact (i.e., teetering), and then back to three or more points of contact from falling caused by gravity. In alternative track chassis suspension systems that have been developed by manufacturers heretofore to help minimize or mitigate the effects of teetering, proper operating tension in tracks that are included in such alternative systems is sometimes lost, which can give rise to various negative effects on the overall suspension system. For example, it is now largely conventional for track suspension systems to include bogie suspensions, or springs, or even elastomeric dampening elements on the bogies to help absorb the impact of objects being driven over. Such track suspension dampening systems, however, alter and sometimes adversely affect the tension in a vehicle's track when active and thus ultimately do little to help address the problem of teetering.

Accordingly, in a track system for a heavy vehicle or a vehicle that performs utility work, there is a problem inherent in providing a rigid support bed for the riding of the vehicle on its tracks. In the resulting bogie or slide rail, or system that combines such features, the vehicle's track must not slack in tension. Otherwise, reduction in vehicle drive capability, drive cog “jumping,” or excessive drive cog wear can undesirably occur. Furthermore, a vehicle track bed with no suspension often results in a bumpy ride, even over small objects that stand up or jut from a landscape, as compared to the average level of the surface over which the track beds are driven. A solution is thus needed that provides independence of the front and rear of the track bogie or slide rail system so that each of the vehicle's tracks is significantly less likely to pivot or teeter at one point when going over an object with a significant variance in height as compared to the average surface level of the ground.

In view of the above, it would be advantageous to provide two independent track bed suspension systems within one overall track bed such that the track bed can operate almost like a configuration with two independent tracks per side of the vehicle. These independent track bed suspension systems must also act in order to maintain track tension for the purpose of effective track drive.

### SUMMARY OF THE INVENTION

The present invention provides a suspension system for a track chassis on a vehicle with a rotatable drive axle. In one practicable embodiment, the suspension system includes a track frame, a rotatable drive wheel, a plural number of support bars, a plural number of bogie wheels, a closed-loop track, and a plural number of shock absorbers. The track frame is mounted to the vehicle, and the drive wheel is in rotary communication with the drive axle of the vehicle. The support bars are pivotally attached in independent fashion to the frame, and multiple bogie wheels are rotatably mounted to each of the support bars. The track is looped about the drive wheel and the bogie wheels so as to engage the outer peripheries of the drive wheel and the bogie wheels. The shock absorbers are respectively connected between the support bars and the frame so that the bogie wheels are biased against the inner periphery of the track for thereby sustaining slack-minimizing tension in the track. In this configuration, an individual track on a vehicle is better able to maintain at least two points of contact between the outer periphery of the track and ground as the vehicle travels over the ground. In this way, a two-tracked vehicle is ultimately better able to maintain a total of at least three points of contact between the outer peripheries of its tracks and ground as the vehicle travels over the ground.

It is therefore an object of the present invention to provide a track chassis suspension system that has a plurality of track bed supports that independently accommodate activation to aid vehicle ride and stability when traveling and climbing over terrain or objects.

It is another object of the present invention to provide a track chassis suspension system that has a plurality of track bed supports that provide suspension while maintaining proper track tension.

In one embodiment, a simple pivoting system of the independent track bed support, or bogie or slide rail carrier could be pivoted with such geometry, in conjunction with other track support elements, such that the track tension can effectively be maintained.

It is yet another object of the present invention to provide a track chassis suspension system that has a plurality of track bed supports that have independent shock-absorbing capabilities.

It is a further object of the present invention to provide a track chassis suspension system that has two bogie wheel carrier chassis mounted within the primary track chassis, such that the track bed is effectively supported, and yet allows the track to flex and ride over an object while the two-tracked vehicle maintains at least three points of contact with the ground.

Furthermore, it is believed that various alternative embodiments and other objects of the present invention will become apparent to those skilled in the art when the detailed description of the best mode(s) contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a side view of a conventional track chassis as used on a vehicle. This view further shows utilization of a track chassis where the prior art chassis with dampening bogies is riding over an object and creating a period of time when the vehicle loses stable vehicle contact with ground.

FIG. 2 illustrates a perspective view from the side of the present invention as used on a vehicle having a personal mobility usage. This view further shows utilization of a track chassis suspension system having a plurality of track bed supports.

FIG. 3 illustrates a side view of the present invention as used on a vehicle having a personal mobility usage. This view further shows utilization of a track chassis suspension system that has a plurality of track bed supports where the bogie chassis are active in accommodating a ride over an object while maintaining stable contact between the vehicle and the ground.

FIG. 4 illustrates a perspective view of the present invention as used on a vehicle having a personal mobility usage. This view further shows utilization of a track chassis suspension system having a plurality of track bed supports.

FIG. 5 illustrates a top view of the present invention as used on a vehicle having a personal mobility usage. This view further shows utilization of a track chassis suspension system having a plurality of track bed supports.

FIG. 6 illustrates a perspective view of a bogie wheel carrier chassis and pivot and suspension system of the present invention as used on a vehicle having a personal mobility usage. This view further shows utilization of a track chassis suspension system that has multiple track bed supports.

### LIST OF PARTS AND FEATURES

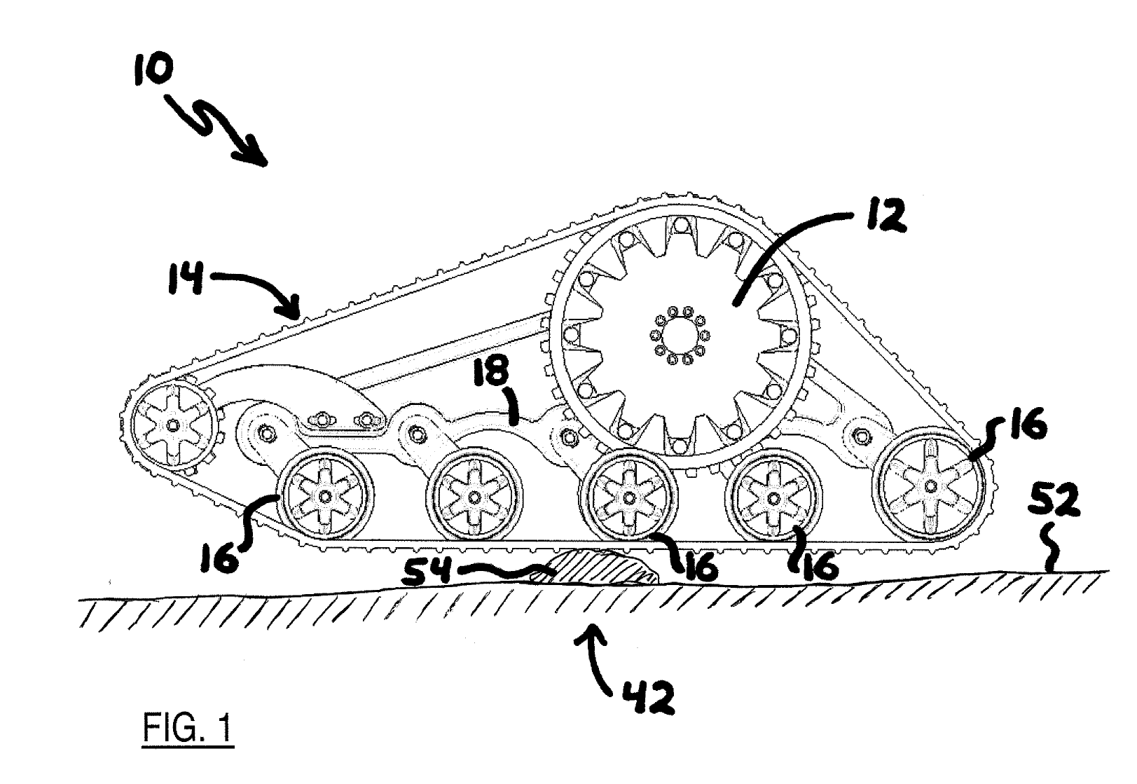

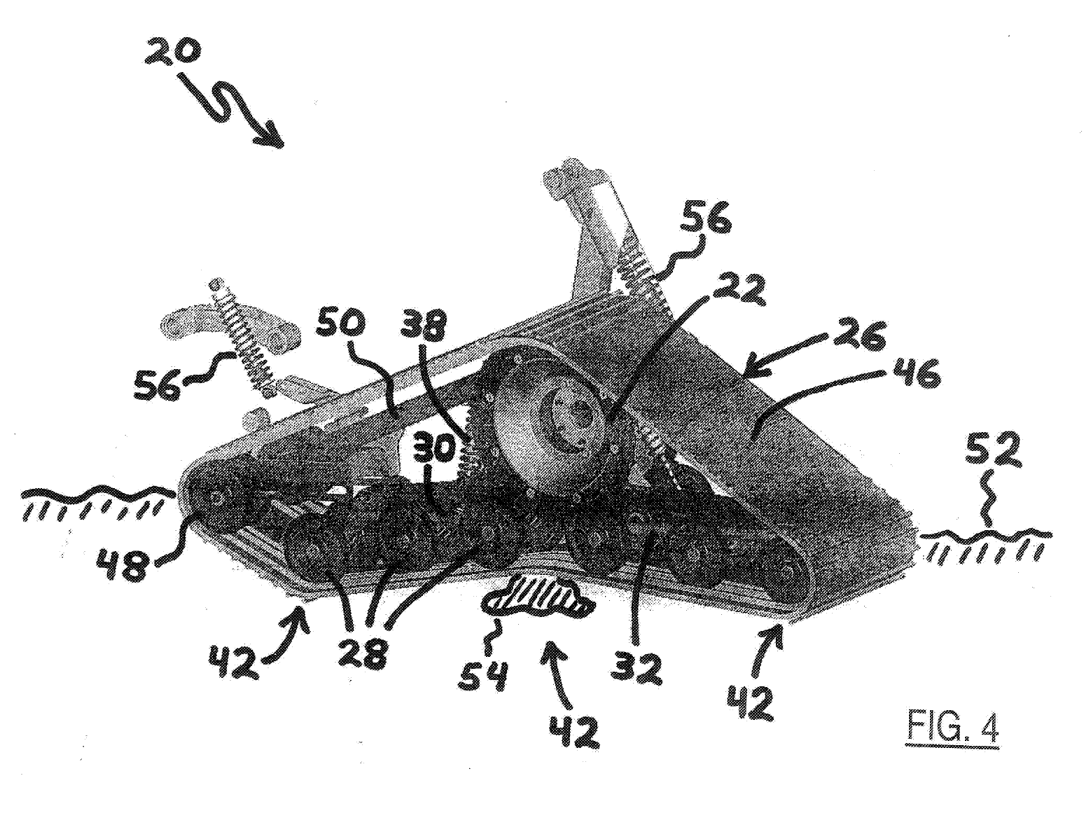

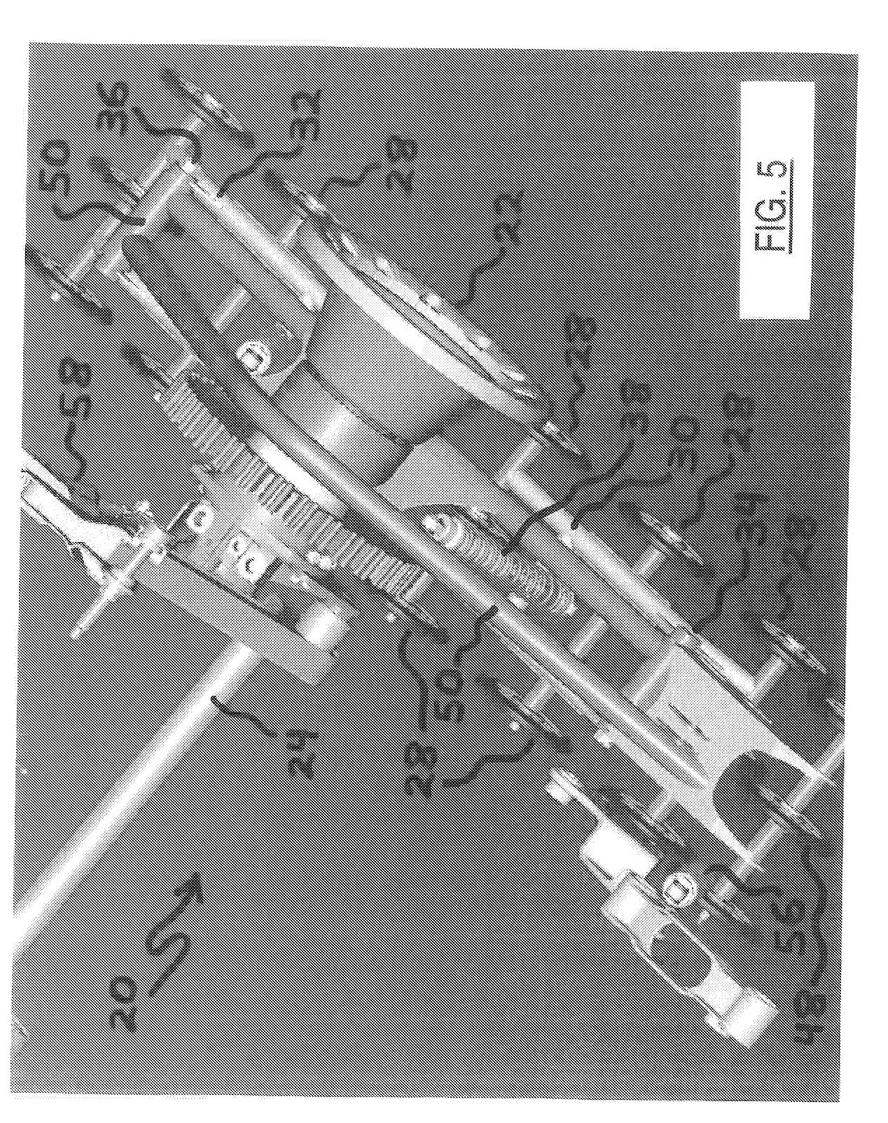

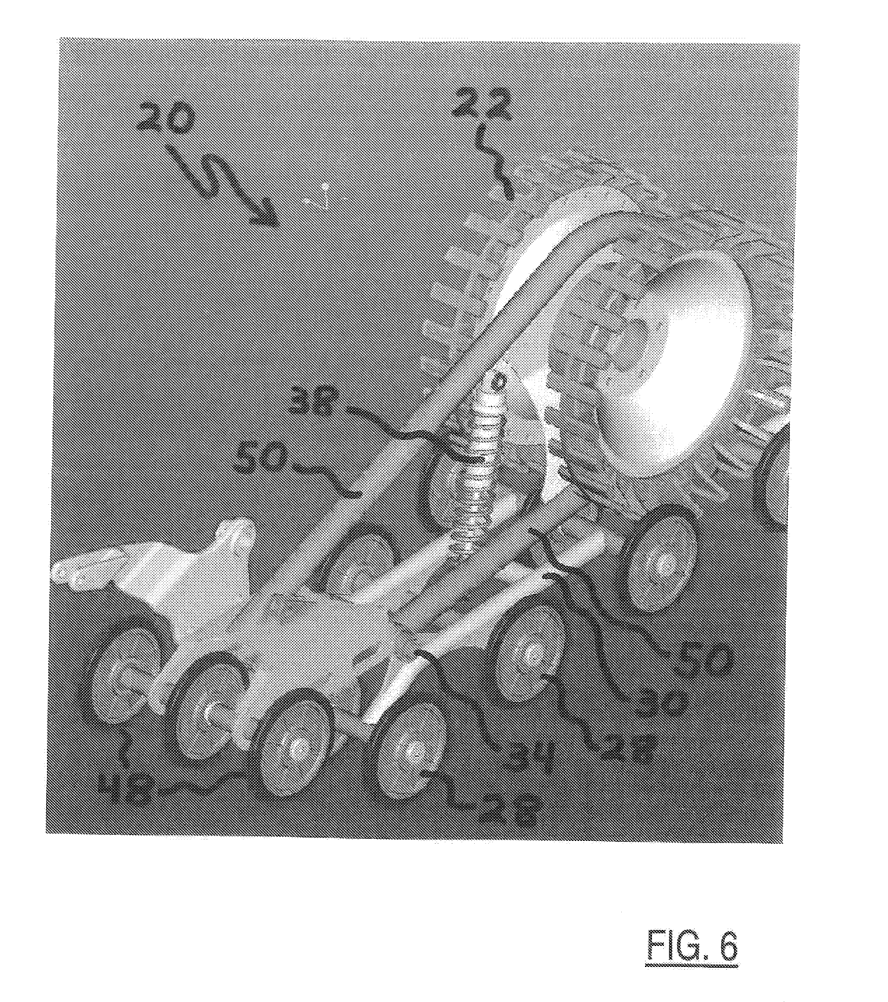

To facilitate a proper understanding of the present invention, a list of parts and features highlighted with numeric designations in FIGS. 1 through 6 is set forth hereinbelow.

10 track chassis suspension system (prior art)

12 drive wheel

14 track

16 bogie wheel(s)

18 support bar

20 track chassis suspension system

22 drive wheel

24 drive axle

26 closed-loop track

28 bogie wheel(s)

30 support bar

32 support bar

34 pivotal attachment point

36 pivotal attachment point

38 shock absorber

40 shock absorber

42 point(s) of contact

44 inner periphery (of track)

46 outer periphery (of track)

48 guide wheel(s)

50 track frame

52 ground

54 object, bump, or change in ground topography

56 shock absorber(s)

58 actuator (for example, a telescoping cylinder)

### DETAILED DESCRIPTION OF THE INVENTION

As will be understood from the drawings, the geometry of the chassis pivot is designed to maintain track tension and is further determined by keeping the track tension essentially constant. For example, FIG. 1 generally illustrates a track chassis suspension system 10 in accordance with the prior art. The track chassis suspension system 10 includes a drive wheel 12 that is in rotary communication with the drive axle of a ground vehicle (not fully shown). The drive wheel 12 engages a track 14 to drive the track 14, as will be understood by those of ordinary skill in the art. The track chassis suspension system 10 includes a plurality of bogie wheels 16 that together provide shape to the track 14 and maintain tension in the track 14 as well. However, as is common in such prior art track chassis suspension systems, the bogie wheels 16 are coupled to a single support bar 18 such that the wheels 16 generally move together and generally do not move independently with respect to one another. Therefore, when the track chassis suspension system 10 runs over and contacts a bump 54 on the ground 52, the entire suspension system 10 is momentarily raised such that zero or only one point on the track 14 of the suspension system 10 is directly or indirectly engaged with the ground 52.

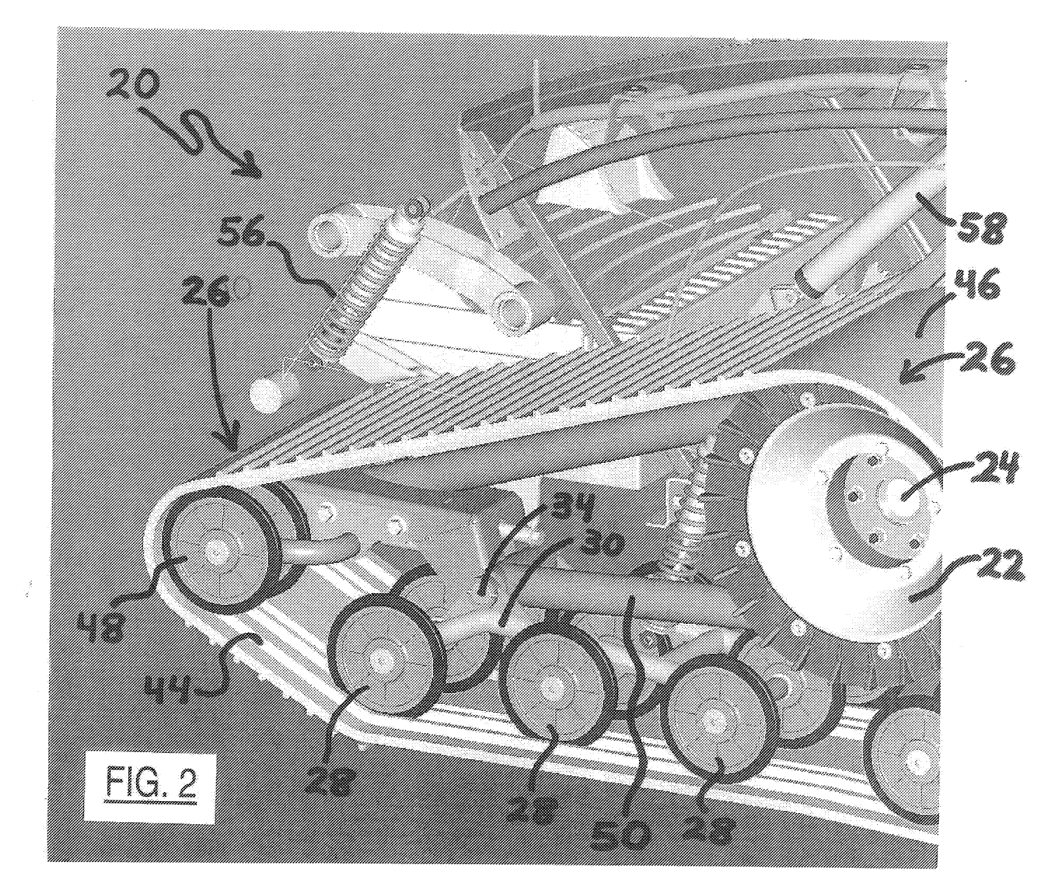

FIGS. 2 through 6 illustrate a track chassis suspension system 20 in accordance with the present invention. As illustrated, the track chassis suspension system 20 includes a rotatable drive wheel 22 that is in rotary communication with a rotatable drive axle 24, which is rotatably mounted on a ground vehicle (not fully shown). It is to be understood that a second track chassis suspension system, which is generally a mirror image of the track chassis suspension system 20, is located and mounted in a similar fashion on the other side of the vehicle as well. During operation, the drive wheel 22 rotates and engages a closed-loop track 26 so as to drive the vehicle, as will be understood by one of ordinary skill in the art. As further illustrated, the track chassis suspension system 20 also includes a plurality of bogie wheels 28 that provide shape to the track 26 and maintain tension in the track 26 as well.

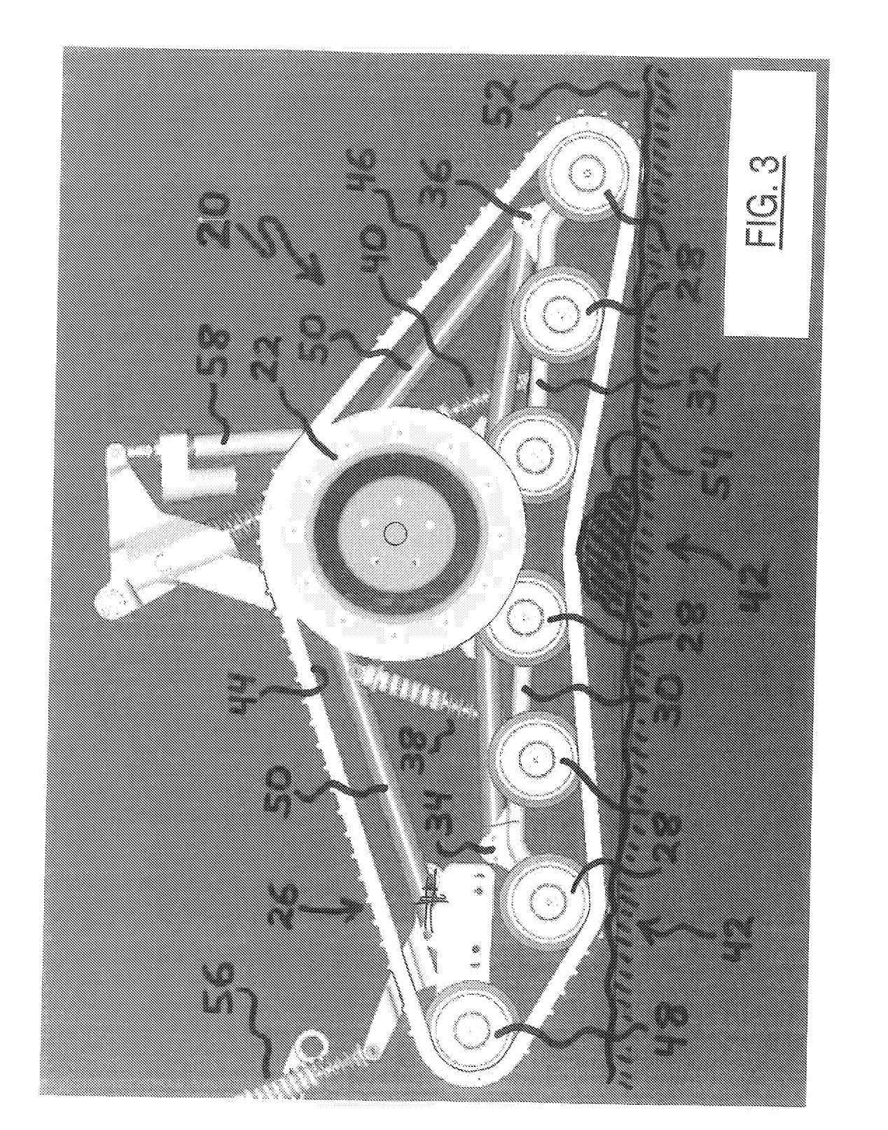

In the embodiment illustrated in FIGS. 2 through 6, the track chassis suspension system 20 includes a track frame 50 mounted to the side of the vehicle. In addition thereto, the suspension system 20 also includes multiple support bars 30 and 32 pivotally mounted or attached in independent fashion to the frame 50. One or more guide wheels 48 is rotatably mounted and coupled to the frame 50, and a plural number of the bogie wheels 28 is rotatably mounted and coupled to each of the support bars 30 and 32. In this configuration, the track bed support bars 30 and 32 can move and pivot independently from each other because the support bars 30 and 32 are pivotally mounted or attached to the track frame 50 separately. Therefore, as best shown in FIG. 3, when the track chassis suspension system 20 travels over ground 52 with an uneven topography, the support bars 30 and 32 can pivot about attachment points 34 and 36 respectively so that at least two points on the track 26 are maintained in engaging contact with the ground 52.

Furthermore, the track chassis suspension system 20 also includes a plural number of shock absorbers 38 and 40 respectively connected between the support bars 30 and 32 and the track frame 50 so that the bogie wheels 28 are biased against the inner periphery 44 of the track 26 for thereby maintaining slack-minimizing tension in the track 26. In this configuration, the shock absorbers 38 and 40 help maintain ground-engaging contact between the outer periphery 46 of the track 26 and the ground 52 by allowing that support bars 30 and 32 along with their bogie wheels 28 to move upward as needed and by also biasing the bars 30 and 32 and wheels 28 downward to facilitate ground engagement. In addition thereto, the shock absorbers 38 and 40 also help provide other suspension functions as will be understood by one of ordinary skill in the art.

Moreover, as further illustrated in FIGS. 2 through 6, the track chassis suspension system 20 also includes both a shock absorber 56 and an actuator 58 mounted between the track frame 50 and the vehicle. In general, the actuator 58 serves to help adjustably position the track frame 50 alongside the vehicle. Although other types of actuators may alternatively be utilized, the actuator 58 may particularly be, for example, a telescoping cylinder.

Lastly, it is to be understood that the track chassis suspension system can be suspended in other ways independent of the internal suspension system of the track chassis. In one embodiment, for example, the plurality of track bed supports can be pivotally supported such that activation of the independent track bed supports accommodates desired terrain absorption while also maintaining track tension. In another embodiment, the plurality of track bed supports may chassis carry a plurality of bogie wheels. In still another embodiment, the plurality of track bed supports may chassis carry a slide rail track support system. Furthermore, each of the plurality of track bed supports may utilize a shock absorber for both absorption of motion and dampening of the motion. Additionally, each of the plurality of track bed supports may also utilize a spring and elastomeric absorption system for both absorption of motion and dampening of the motion. Ultimately, by maintaining two points of ground contact on each of a two-tracked vehicle's tracks when driving over a bump or other obstacle on the ground, a two-tracked vehicle can thereby better simulate balanced and stable four-wheel drive performance.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. A suspension system for a track chassis on a vehicle with a rotatable drive axle, said suspension system comprising:
a track frame mounted to said vehicle;
a rotatable drive wheel in rotary communication with said drive axle of said vehicle;
a plural number of support bars pivotally attached in independent fashion to said frame;
a plural number of bogie wheels rotatably mounted to each of said support bars; and
a track looped about said drive wheel and said bogie wheels so as to engage the outer peripheries of said drive wheel and said bogie wheels.

2. A track chassis suspension system according to claim 1, wherein said suspension system further comprises an actuator mounted between said track frame and said vehicle for adjustably positioning said frame alongside said vehicle.

3. A track chassis suspension system according to claim 2, wherein said actuator is a telescoping cylinder.

4. A track chassis suspension system according to claim 1, wherein said suspension system further comprises at least one shock absorber mounted between said track frame and said vehicle.

5. A track chassis suspension system according to claim 1, wherein said track frame is substantially configured around the hub of said drive wheel.

6. A track chassis suspension system according to claim 1, wherein said plural number of support bars is two.

7. A track chassis suspension system according to claim 1, wherein said suspension system further comprises a plural number of shock absorbers respectively connected between said support bars and said frame so that said bogie wheels are biased against the inner periphery of said track for thereby maintaining slack-minimizing tension in said track.

8. A track chassis suspension system according to claim 7, wherein said plural number of shock absorbers equals said plural number of support bars.

9. A track chassis suspension system according to claim 1, wherein said plural number of bogie wheels is two to three pairs.

10. A track chassis suspension system according to claim 1, wherein said suspension system further comprises at least one guide wheel rotatably mounted to said track frame such that said track is looped about said drive wheel, said bogie wheels, and each said guide wheel so as to engage the outer peripheries of said drive wheel, said bogie wheels, and each said guide wheel.

11. A suspension system for a track chassis on a vehicle with a rotatable drive axle, said suspension system comprising:
a track frame mounted to said vehicle;
a rotatable drive wheel in rotary communication with said drive axle of said vehicle;
a plural number of support bars pivotally attached in independent fashion to said frame;
a plural number of bogie wheels rotatably mounted to each of said support bars;
a track looped about said drive wheel and said bogie wheels so as to engage the outer peripheries of said drive wheel and said bogie wheels; and
a plural number of shock absorbers respectively connected between said support bars and said frame so that said bogie wheels are biased against the inner periphery of said track for thereby maintaining slack-minimizing tension in said track.

12. A track chassis suspension system according to claim 11, wherein said suspension system further comprises an actuator mounted between said track frame and said vehicle for adjustably positioning said frame alongside said vehicle.

13. A track chassis suspension system according to claim 12, wherein said actuator is a telescoping cylinder.

14. A track chassis suspension system according to claim 11, wherein said suspension system further comprises at least one shock absorber mounted between said track frame and said vehicle.

15. A track chassis suspension system according to claim 11, wherein said track frame is substantially configured around the hub of said drive wheel.

16. A track chassis suspension system according to claim 11, wherein said plural number of support bars is two.

17. A track chassis suspension system according to claim 11, wherein said plural number of shock absorbers equals said plural number of support bars.

18. A track chassis suspension system according to claim 11, wherein said plural number of bogie wheels is two to three pairs.

19. A track chassis suspension system according to claim 11, wherein said suspension system further comprises at least one guide wheel rotatably mounted to said track frame such that said track is looped about said drive wheel, said bogie wheels, and each said guide wheel so as to engage the outer peripheries of said drive wheel, said bogie wheels, and each said guide wheel.

20. A suspension system for a track chassis on a ground vehicle with a rotatable drive axle, said suspension system comprising:
a track frame mounted to said vehicle;
a rotatable drive wheel in rotary communication with said drive axle of said vehicle;
a plural number of support bars pivotally attached in independent fashion to said frame;
a plural number of bogie wheels rotatably mounted to each of said support bars;
a track looped about said drive wheel and said bogie wheels so as to engage the outer peripheries of said drive wheel and said bogie wheels; and
a plural number of shock absorbers respectively connected between said support bars and said frame so that said bogie wheels are biased against the inner periphery of said track for thereby maintaining slack-minimizing tension in said track;
whereby maintaining at least two points of contact between the outer periphery of said track and ground is facilitated.
